(19) United States
(12) Patent Application Publication
(10) Pub. No.: US 2011/0022621 A1
(43) Pub. Date: Jan. 27, 2011

(54) DYNAMICALLY NAMING COMMUNITIES WITHIN ONLINE SOCIAL NETWORKS

(75) Inventors: Qingshan Luo, Beijing (CN); Yingwei Cui, Los Altos, CA (US); Bo Zhang, Jilin City (CN)

Correspondence Address: GOOGLE / FENWICK, SILICON VALLEY CENTER, 801 CALIFORNIA ST., MOUNTAIN VIEW, CA, 94041, US

(73) Assignee: GOOGLE INC., Mountain View, CA (US)

(21) Appl. No.: 12/673,760

(22) PCT Filed: Aug. 17, 2007
(86) PCT No.: PCT/CN07/02487

§ 371 Date: Feb. 16, 2010

(51) Int. Cl. G06F 17/30

(52) U.S. Cl. 707/769; 707/E17.108

(57) ABSTRACT

An online social networking system can be used to create a new online community in a social network. The product comprises code for carrying out a method that begins with receiving a search query for searching online communities within the online social network from a user. The search query is used to search in a database of pre-existing online communities. The user is provided with the option of creating a new online community based on the search query, and a new online community based on the search query that includes the user as a member is created. Content for the new online community is searched for and located, and code for, when executed, displaying the located content to the new online community generated.

### FIELD OF THE INVENTION

The invention generally relates to social networks. More particularly, the invention relates to creating communities within online social networks.

### BACKGROUND OF THE INVENTION

Online social networks connect users with common interests to each other. Social networking sites such as Myspace.com, Friendster.com, Tribe.net, and Orkut.com foster relationships between their members, thereby offering a higher level of affiliation and trust than other online media through which users can interact with each other such as electronic message boards or forums.

Communities, organized around a theme, interest, or common endeavor represent a major organizing unit in a number of online social networks. Members within a community can observe, interact, and form affiliations with other members of a community by virtue of their community activities. Community members may decide what other users to reach out to or network with based on another user's community memberships.

Most social networks provide a search engine that allows users to search for content of interest using keywords. For example, a user can search for “competitive ballroom dancing”, and the search engine will return some number of items within the social network that have matching keywords, such as the personal pages of individual users, documents, message posts, and forums. However, if there are insufficient results, for example, there are no pages, documents, forums, etc. that include the search query terms, then the user is typically provided with a message such as, “No matching documents found.” At this point the user is left to enter yet another search to find content that is relevant to their interests. This process can be frustrating to the user who must conduct repeated searches.

### SUMMARY OF THE INVENTION

An online community can be created within an online social network based on a search query. In an embodiment, a search query for searching online communities within the online social network is received from a user. The search query is used to search in a database of pre-existing online communities. The user is provided with the option of creating a new online community based on the search query, and a new online community based on the search query that includes the user as a member is created. Content for the new online community is searched for and located, and code is generated that, when executed, displaying the located content to the new online community generated.

Other methods can be used to create online communities in social networks. In another embodiment, an object to be posted to a social network and a label name to associate with the object are received. A database of pre-existing online communities is searched for any communities that contain one or more terms of the label name, and a new online community is created. The new online community is named with the label name, and a webpage generated for the new, named online community.

### BRIEF DESCRIPTION OF THE DRAWINGS

FIG. 1 is a block diagram of an online social networking system in accordance with one embodiment of the present invention.

FIG. 2 depicts a webpage of an online community of a social network in accordance with one embodiment of the present invention.

FIG. 3 is a high-level block diagram of elements on a social network server.

FIG. 4 is a flow chart illustrating methods for the creation of communities.

The figures depict embodiments of the invention for purposes of illustration only. One skilled in the art will readily recognize from the following description that alternative embodiments of the structures and methods illustrated herein may be employed without departing from the principles of the invention described herein.

### DETAILED DESCRIPTIONS

### Overview

The present disclosure describes various methods and systems for the creatin of communities in online social networks and distribution of content within them. Techniques and systems for ranking objects such as users, forum topics, albums, blogs, and communities within social networks are also disclosed. The techniques described herein can be applied to various online social networks including public and private online networks, social networks within enterprises, and social networks within other environments.

The features and advantages described herein are not all-inclusive and, in particular, many additional features and advantages will be apparent to one of ordinary skill in the art in view of the figures and description. It should also be noted that the language used in the specification has been principally selected for readability and instructional purposes, and not to limit the scope of the inventive subject matter. Furthermore, the description herein focuses on selected features of online social networks including communities, forums, and ranking systems. Other techniques, functionalities, and components not discussed, whether conventional or custom, can be used as desired in conjunction with providing these features, as will be apparent in light of this disclosure.

### System Architecture

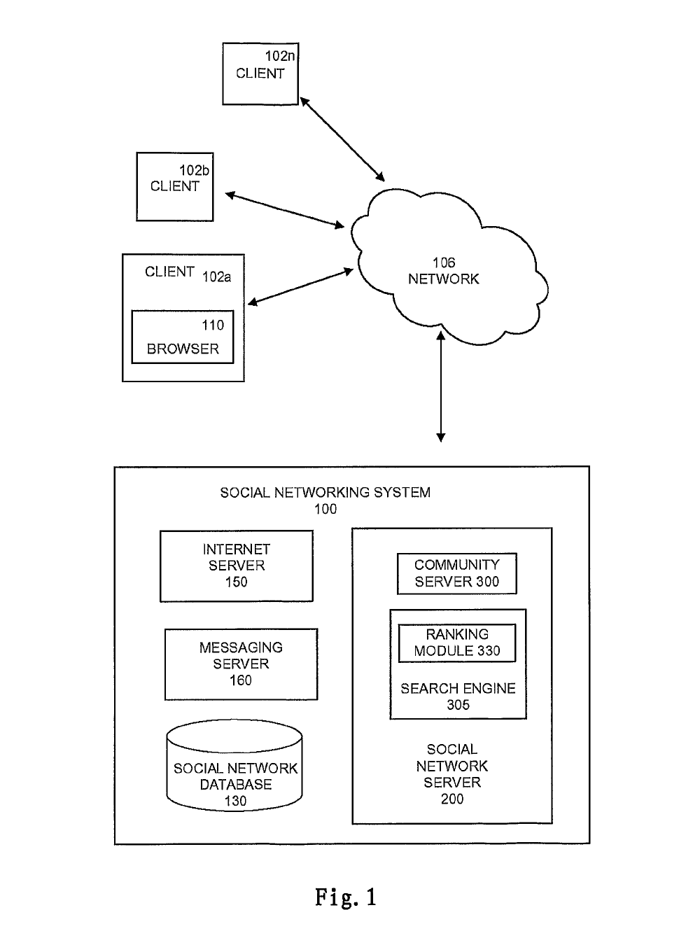

FIG. 1 is a block diagram of an online social networking system in accordance with one embodiment of the present invention. The social networking system 100 communicates with multiple client devices 102 over a network 106. Each of the client devices 102 includes a browser 110 or comparable application for providing and accessing content managed by the social networking system 100. (In FIG. 1 and the remaining figures, a letter after a reference numeral, such as “102a,” is a reference specifically to the element having that particular reference numeral. A reference numeral in the text without a following letter, such as “102,” is a general reference to any or all instances of the element bearing that reference numeral; e.g. “102” refers to reference numerals “102a,” “102b,” and/or “102n” in the figures.) The social networking system 100 includes a social network server 200 and an internet server 150. The social network server 200 includes a community server 300 and ranking module 330, and is coupled to a social network database 130. These elements are used by the social network server 200 to provide social network services and content to clients 102 and facilitate social networking interactions between them.

The social network server 200 enables users of devices such as clients 102, to interact with other users in an online social network. The various servers in the social networking system 100 may comprise a dedicated server-class computer system comprising applications, one or more processors, memory, storage, and associated software applications. The servers may also individually comprise multiple computers operating under a load balancing scheme, or other mechanisms for distributing processes and data.

The social networking system 100 supports an online social network comprising a set of entities who are members of the social network, and who communicate with each other via the services and facilities of the system 100. A member of an online social network can be any entity such as, for example, a person, an organization, a business, a corporation, a community, or other suitable entity. These entities can have various types of social relationships, such as community membership, professional or social organizations, friendships, or simply groups with common interests.

Each member is represented by a stored profile that comprises one or more entries containing information about the member. A member may be represented by a person profile, business profile, organizational profile, or a profile belonging to any other class of profile. Each member has an identifier that can be used to identify the member within the network (e.g., a user name). Each profile type is associated with different types of entries. For instance, a person profile can include entries comprising contact, personal, and professional information, while a business profile may include entries describing industry information or financial information. Other entry types can store social, demographic, networking, or other types of information. Personal profile entries may comprise contact information such as email addresses, mailing addresses, IM name, or phone number, personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, or favorite cuisines, professional information such as skills, career, or job description; photographs of a person or other graphics associated with an entity, or any other information describing, identifying, or otherwise associated with a profile. Entries for a business profile can comprise industry information such as market sector, customer base, location, or supplier information, financial information such as net profits, net worth, number of employees, stock performance, or other types of information associated with the business profile.

Each member's profile includes information that associates the member with the profiles of other members in the social network. An association between members has a type. Types of associations include, for example, friendships, romantic relationships, business relationships, acquaintances, community associations, activity partner associations, common interest associations, common characteristic associations, or any other suitable type of association between profiles. For example, a user may designate himself as a “fan” or a “friend” of another user. A given type of association can have multiple levels to indicate the degree of the association. For example friendship levels can include, for example, a “haven't met” level, an “acquaintance” level, a “friend” level, a “good friend” level, a “best friend” level, or other suitable levels. Similar levels for other types of associations are readily determined by those of skill in the art.

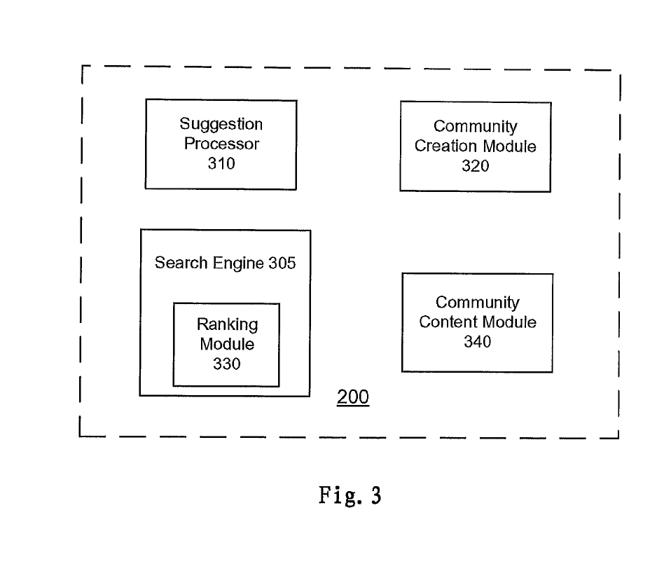

The social network system 100 further supports the creation and manipulation of a variety of social network objects. The social network objects include the members themselves (as represented by their user name), as well and the various types of content objects supported by the social network, including forums and message posting therein, blogs, community, albums, images, media files, articles, documents, and the like. Users of clients 102 can enter search queries (e.g., via a browser) to search for any of these objects in the social network system 100. The search queries are provided over the network 106 to the social network server 200 and processed by a search engine 305. The search engine 305 comprises code for parsing search queries, a crawler for locating social network objects, and a ranking module 330 for ranking and indexing social network objects. The search engine receives search queries and can perform Boolean or relevance searching based on the queries. The results are ordered in accordance with the indexing performed by the ranking module, and provided to the community server 300. The community server 300, in turn, takes the search results and provides them in a format that the requesting client 102 can use to present the data to the user (e.g., via a browser or other application). If no matches are found, alternative search queries may be provided to users, as is discussed in greater detail with respect to FIG. 3.

The ranking module 330 evaluates and ranks various online social network objects returned in response to a query and is described in greater detail with reference to FIG. 3. As users take actions within a social network, such as registering in a network, designating another member as a friend or fan, joining a community within the network, viewing webpages, annotating profiles, and posting content, these events are indexed. The indexed information includes the type of object being created, manipulated, or accessed, the type of event, and the associated details, such as a timestamp, user, and so forth. This event data can then be used as the basis of object rankings. The ranking module 330 accesses this ranking data and processes it to determine scores and rankings for social network objects. The particular ranking function applied to each object and the ranking data to which the ranking function is applied depends on the object's type. The ranking functions can be based on either direct, derived, or aggregated values. The ranking functions preferably rank objects as an indicator of their popularity, as computed by various metrics, as further described below. For instance, a member can be ranked according to the number of his or her fans and friends, while a community forum can be evaluated based on the number and recency of posts in the forum, the number of members, the rate at which posts are being made or the rate of member sign up, and so forth. On a periodic basis, the rankings are refreshed and saved into an index. The indexed ranking data is used to order search results, select objects for presentation, and/or designate certain social network objects as popular.

The social network server 200 also comprises a community server 300 for carrying out various aspects of online community management such as creating and operating communities. Communities are named and preferably have descriptions that specify the types of topics, events, and members of the community. Communities may also have keywords and/or labels that indicate the types of topics and subject categories that are off interest to the members of the community, and which can be used to classify the community and its members. Posting within a community may be moderated by a member or online community provider comprising a community “owner” or may be unmoderated. Community membership may be restricted in some manner or may be open to the public at large.

Communities may be placed into various categories and subcategories of organization. Community subcategories can comprise groups of profiles within a larger category that share common interests or characteristics independent from the entire community. For example, a general “basketball players” community category can comprise communities of basketball players for any location or type of basketball. A sub-community category within the basketball community category could comprise communities of basketball players belonging to a certain geography. Thus, a “California basketball players” sub community category could comprise communities including “LA basketball player,” “Oakland basketball player,” and “Santa Clara basketball player” communities. The general “basketball community” can also be placed into a larger overall “basketball” community that includes “basketball player” communities as well as “basketball watcher” communities.

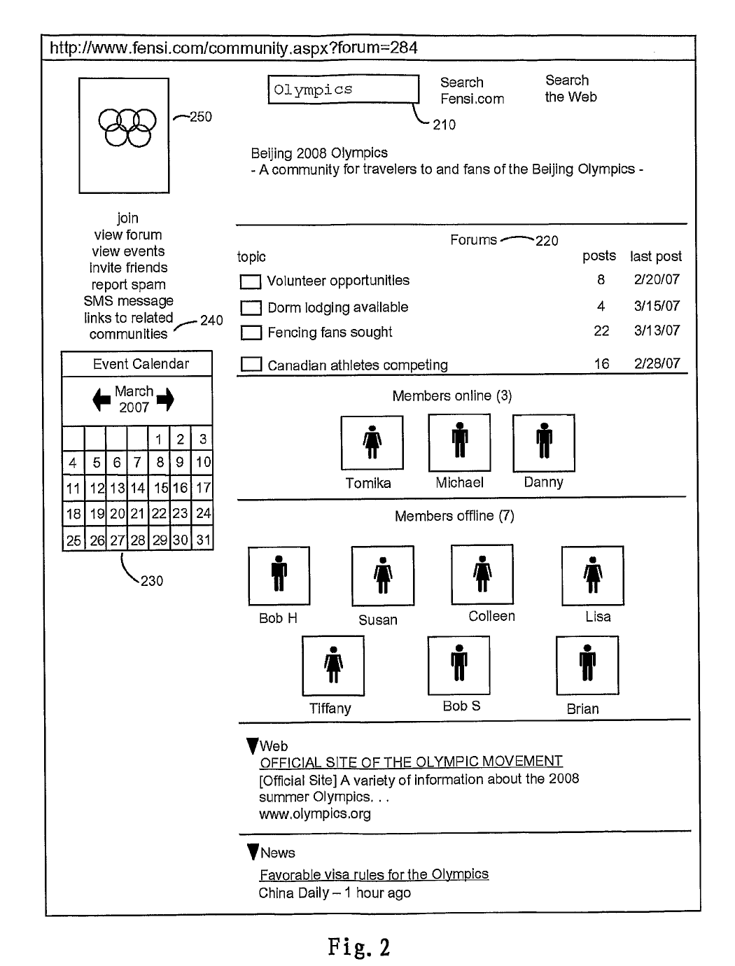

The community server 300 supports the management of variety of community features and social objects therein, such as forums, events, messaging, blogs, photo albums, maps, links to news and web pages, relevant advertisements, and affinity and other links to other members or communities, as described in greater detail with reference to FIG. 2. The community server 300 comprises code for distributing content within community forums, blogs, event calendars, and other community medium. The community server also stores information about policies for individual communities including, membership, posting, content distribution, privacy, posting of photos and other content, management of subtopics, and other policies.

Community content, links, images, postings, relationships, descriptions, and other community data as well as member data and profiles are stored by community server 300 within the social network database 130. The database 130 may be implemented as one or more relational database management system (RDBMS), lightweight database access protocol (LDAP), flat file, and/or other databases, or using another database architecture. Data storage elements may include any one or combination of methods for storing data, including without limitation, arrays, hash tables, lists, and trees. Other similar types of data storage devices can be accessed by the server 200. The community server 300 receives data comprising the profiles and communities from the social network database 130 and also sends data comprising communities and profiles to the social network database 130 for storage. The social network database 130 is communicatively coupled to the social network server 200 by way of a network connection (not shown).

The social network server 200 is coupled to an internet server 150 and a messaging server 160. The internet server 150 comprises a server for serving content to requesting clients. Through its connection to the internet server 150, the social network server 200 can provide internet content to online social networks and communities, through links to relevant web pages, news, advertisements, and pages discussed within community forums. In an embodiment, the internet server 150 or social network server 200 is coupled to a messaging server 160 for providing instant messaging, email, or other messaging services. The messaging server 160 also or alternatively comprises a mobile device messaging server that is in communication with a cellular phone or other mobile communications network. The social network server 200 can communicate and exchange messages on behalf of social network members using the server 160.

The client devices 102 shown in FIG. 1 each comprise a processor 110, memory, network interface, display device, a computer-readable storage, and input devices, as well as optional peripheral devices. The processor executes computer-executable program instructions stored in the memory to access the functionality of the social network server 200. Examples of client devices 102 are personal computers, digital assistants, personal digital assistants, cellular phones, mobile phones, smart phones, pagers, digital tablets, laptop computers, Internet appliances, and other processor-based devices. In general, a client device 102 may be any type of processor-based device that is connected to a network 106 that comprises a browser 110 or similar hosted application program. Client devices 102 may operate on any operating system capable of supporting a browser-enabled application or browser, such as Microsoft®, Windows®, or Linux. The client devices 102 include a browser 110 or similar application program for accessing the social networking system 100. The social network server 200 generates and serves community webpages. It provides HTML (hypertext markup language), images, scripting language (e.g., JavaScript, JScript, Visual Basic Script), XSLT (extensible style sheet language transformation), and other static elements that are used by a browser 110 on a client device 102.

The network 106 enables data communication between and among the entities shown in FIG. 1. The network 106 will typically include some combination of local area networks (LAN) or wide area networks (WAN) in communication with the Internet, using standard communications technologies and/or protocols. Portions of any of these networks can be wired or wireless, using the associated technologies (e.g., Ethernet, 802.11 802.16, integrated services digital network (ISDN), digital subscriber line (DSL)), and protocols (e.g., TCP/IP, HTTP, SMTP, and FTP). The data exchanged over the network 106 can be represented using technologies and/or formats including the hypertext markup language (HTML), the extensible markup language (XML), the simple object access protocol (SOAP) and/or other formats. In addition, all or some of links can be encrypted using conventional encryption technologies such as the secure sockets layer (SSL), Internet Protocol security (IPsec), Secure HTTP and/or virtual private networks (VPNs). In another embodiment, the entities can use custom and/or dedicated data communications technologies instead of, or in addition to, the ones described above.

It should be noted that embodiments of the present invention may comprise systems having different architectures than that which are shown in FIG. 1. The system 100 shown in FIG. 1 is merely exemplary, and is used to help explain the social network elements and methods illustrated in FIGS. 2-6.

### Illustrations of an Online Community

FIG. 2 depicts an example of webpage of an online community of a social network, as provided by the social networking system 100. A wide variety of services and features are provided for members of the online community “Beijing 2008 Olympics.” A description of the community, “A community for travelers to and fans of the Beijing Olympics” is provided on the page, as well as an image 250 that represents the community. The name, description, and image of the community 205 can be provided by the community creator or author of the community, or may be supplied by a community content module as described below. The community server 300 of FIG. 1 supports the various services described and/or shown. As shown, the status of certain members is depicted as online and offline, depending on whether or not the members are logged in to the community or the online social network that the community belongs to.

The community webpage includes a search interface 210 for receiving queries from members seeking content on the online social network. This content can comprise various social network objects such as members, discussion forums 220, events, photo albums, blogs, documents, files, and communities. Such objects can be ranked in accordance with any of a variety of ranking popularity functions. Objects with high popularity rankings may be annotated, for instance with a star, or placed into a particular portion of a community webpage such as a “hot pick” or “most popular” section.

The community webpage includes several forums 220 for discussion of various topics, such as “volunteer opportunities,” and “fencing fans sought.” The forums include messages in a discussion thread. Messages can be modified and deleted after their creation by the creator or by an administrator of the community. In an embodiment, messages on the same topic can be browsed from the oldest to the most recent. In addition, a topic can contain an unlimited number of messages. Users can create topics for discussions. In an embodiment, the topic comprises the subject of a first message in a discussion thread. Topics can be modified and deleted after their creation by the creator or by an administrator of the community. Several most recent topics are displayed on the community pages. Communities may allow for “open” posting by members outside of the community. Or they may restrict posts to community members, as specified by the community creator or administrator.

The community webpage also includes an event calendar 230 for storing information about events. Events are short messages describing an event (location, date, etc). In an embodiment, any user can create, modify, and delete their own events as well as post community events. Several most recent events may be displayed on the event calendar 230. The event calendar can be supplemented with geographic information including the location of the event. In an embodiment, a map display of an event location is included in or linked to from the community page. Users can choose to participate in events, and participants in an event may be made visible to other members of the community.

A number of different types of links may be supported in an online social network among users and communities. As shown in FIG. 2, a community can be linked to one or more related communities 240. This helps users find communities of interest. In an embodiment, such related communities are automatically identified by checking what communities have the most members in common, relative to their size. Communities can also be considered “related” if there is a significant degree of overlap between forum topics, titles, keywords, or other community aspects.

A community may have self-regulatory mechanisms. For instance, a member may be able to “report spam” using a report spam button. In addition, a community may have outlinks to relevant content on the internet. Such links may comprise web links, news links, and links to relevant advertisements. The content may be customized based on user activity on the community webpage, for instance within forum, event, or other types of activity. A community may also support messaging by its members. A community member may, for instance, send and receive text, instant, or email messages.

### Social Network Server Elements

FIG. 3 is a high-level block diagram of selected elements on a social network server in accordance with one embodiment of the present invention. The elements comprise a search engine 305, suggestion processor 310, community creation module 320, ranking module 330, and community content module 340. As used herein, the term “module” refers to logic for providing the specified functionality. A module can be implemented in hardware, firmware, and/or software. Preferably, a module is stored on the storage component of an electronic device, loaded into its memory, and executed by the device processor. The community creation module 320 and community suggestion processor 310 facilitate the creation of communities within an online social network. The community content module 340 routes and distributes content within an online social network. The search engine 305 receives and processes search requests and generates search results that include objects on the social network as well as on the Internet generally. It includes the ranking module 330, which evaluates and ranks various objects within a social network.

The community creation module 320 comprises a module for creating online communities. The community creation module 320 enables the dynamic creation of online communities according to specific scenarios. In one scenario, a member types in a search query in order to locate a community of her interests, using for instance a search interface within an online social network. The search engine 305 processes the search query and looks for matches, for instance an exact match to the search query and/or matches to one or more of the search terms. When there are no matches, according to whatever search approach is used by the search engine 305, the community creation module 320 prompts the user to create a new public community with a name supplied by the user. The name is unique among public communities.

In another scenario, the community creation module 320 dynamically creates a public named community when a user attempts to specify a community that does not exist. In such a scenario, a user attempts to apply a label to a social network object such as an event, posting, forum, or blog entry. The search engine searches for any communities that have names that match one or more terms in the label name. If there are no communities that match the label name, the community creation module 320 dynamically creates a community with the label name. Under both of these scenarios, a community is automatically created for the user, bypassing the conventional community creation process.

In an embodiment, the resulting community under either of these scenarios is a public community whose ownership belongs to the public. This means that the community is administered by social network administrators rather than the creator or her designees. Once a community has been created, the community creation module 320 may prompt the user to optionally enter some description, labels, and/or keywords and provide images for the community. The community creation module 320 preferably performs additional steps to automate the population and management of newly created communities. For instance, the community creation module 320 may apply default settings to the community that membership is open to the public, rather than restricted. The new community includes the user as a member.

In addition, the community creation module 320 may implement several controls or policies on the new community that encourages members to join the community by reducing the risk of spam and off-content posting. Such controls may include disallowing the sending of messages to all community members, and disabling anonymous posting by social network users. These controls may be publicized in a community information or profile page. They may be encoded by a social network server into the presentation of community webpages (e.g. with or without a “send to all members” option displayed). Furthermore, a community rules engine may implement controls such that, when a user attempts a prohibited action, they are prevented from doing so. The community creation module 320 may also automatically search for relevant web content such as news, images, and advertising posted on the internet and place such content in a newly created forum or an existing forum. Similar searches for related or relevant communities, members, blogs, and other online social network content can be performed. The searches may be performed based on the community name, or any other content description, keyword, images, or content provided by the user. This information may be used in combination with the user's profile information such as the user's membership in related communities, friends, or fans. For instance, communities that have overlapping keywords with a newly created community may be identified as appropriate for receiving a solicitation to join the new community. A social network server generates code that, when executed, displays a link to the new community to these identified pre-existing communities. Other users within the online social network to whom the new community can be advertised may be identified in a similar way. Users are identified that have provided keywords, labels, postings, or other content to the social network that match the new community's name, keyword, or other description using standard Boolean, relevance, or other matching techniques. Links to the new online community can also be provided to these users.

A suggestion processor 310 may be provided to improve the community creation process carried out by the community creation module 320. The suggestion processor 310 comprises a server and software for providing search results to unmatched search queries using any of a variety of techniques. For instance, in an embodiment, the suggestion processor 310 uses known language processing techniques to identify spelling, grammatical, or other obvious errors in a user query. The suggestion processor 310 devises one or more suggested search terms, based on a dictionary, a directory of existing community names, or the most common spelling of each word in the query, based on queries of other users. The terms may be supplied back to the user, who can be prompted to re-initiate a search based on the revised terms. In another embodiment, the suggestion processor 310 may use other language processing techniques that rely, for instance, on known associations/substitutions of words (as may be provided by a thesaurus or slang dictionary, for instance) to search existing communities and suggest them to a user based on their query. The search may be performed based on the names as well as keywords of existing communities. For example, a user may enter a query like “China Olympic,” or “Peking 2008.” Although there may not be a specific match for either of these community names, the suggestion processor 310, based on information about existing communities or the most common spellings of words based on queries of other users, may suggest the community “Beijing Olympics 2008” to the user. By providing such suggestions, the risk of creating of multiple communities with different names that all are meant to refer to the same thing is minimized.

The community content module 340 comprises code for distributing content within a social network. Users provide content to the online social network such as forums, forum posts, events, blog entries, documents, files, videos, and images. The community content module 340 takes the content and makes it available to other users. In an embodiment, the content module 340 supports multi-community content sharing. When a user creates an object such as a forum within the context of a single community, the user may indicate by direct designation what other communities the forum topic should also be cross-posted to. In an embodiment, the user does not need to directly designate communities for cross-listing of the object contributed by the user. Instead, the user can associate labels with the object. Based on the label, a matching module (not shown) can find relevant communities to which to also cross-post the user's contribution. The community content module 340 receives this information and uses it to provide the object to multiple different communities. Responses to the object, such as follow up posts, entries, or comments provided by other users may also be provided by the community content module 340 within the different communities in which the object is posted. Alternatively, the responses may also be provided in a single webpage accessible to the multiple communities devised by the community content module 340. The ranking module 330 comprises a processor for ranking various social network objects such as users, communities, forums, blogs, blog postings, and photo albums. The ranking module 330 collects data with which the social network objects can be scored and ranked. Object rank can be generated based on extrinsic factors, such as the popularity of the object to users as measured, for example, based on quantity, velocity, or recency of access or responses received, or other intrinsic factors such as the status of the poster of the object. Ranking data such as community traffic may be stored in a social network database. The engine 330 periodically evaluates objects within the social network using the ranking data in order to determine a score or rank for each of the objects.

### Online Community Creation

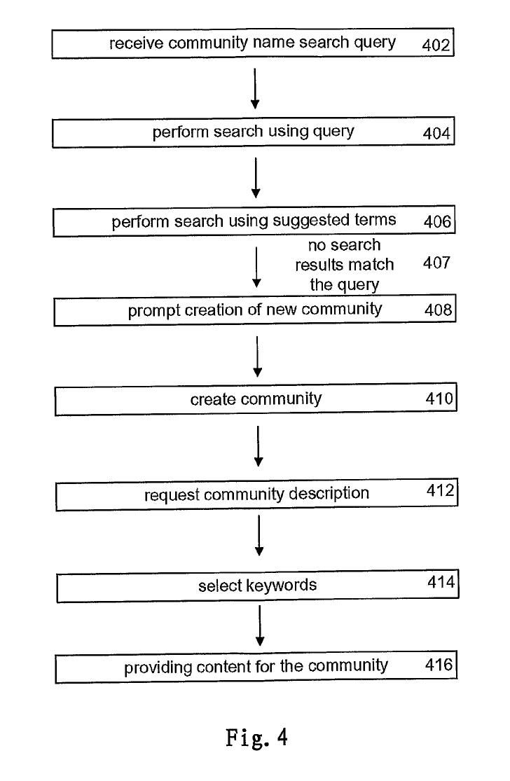

FIG. 4 is a flow chart illustrating methods for the creation of an online community in accordance with an embodiment of the present invention. As shown in FIG. 4, a search query from a user for a community is received 402. Based on a search string provided by the user and a request for a community that matches the string, a search 404 of pre-existing online communities available to the requesting user is performed. The set of communities searched may comprise, for instance, communities that allow public access as well as communities that have restricted access but which are accessible to the user. The database 130 of online communities is searched for names that match the search query. As is known to one of skill in the art, the search may be for an exact match to the search query, or for a match that includes all the terms of the query, or for a match to at least one term in the query. If there are search results, they are presented to the user and the user can decide whether any are suitable. Under one scenario, assuming no exact search results match the query even though other non-exact matches are found, the user is prompted 408 or provided the option to create a new community.

If no search results match 407 the query, several actions are possible. First, the creation of a new community can be immediately prompted 408. Or, before the creation is prompted 408, to ensure that the user has not inadvertently misspelled a term in the search string (for instance, entering “Einsteen” for “Einstein”), or made another potential error (for instance, entering “Theme Parkland” for “Theme Park”), one or more revised search terms may be generated, for example by the suggestion processor described above. The revised query terms may be used to automatically search the database of existing online communities, or, alternatively, provided back to the user. The user may be prompted to re-initiate her search based on the revised search terms.

Assuming no communities match 407 the original or revised search query, the creation of a new community is prompted 408. The user is provided with a link, for instance, to “create a new community.” The user responds affirmatively to the prompt (e.g., selecting the link) in which case a new community is created 410, and given the name of the user's original or revised search query. The new online community includes the user as a member. The user may be requested 412 to provide a short description of the community. Keywords for the newly created community are selected 414 as well. The keywords may be chosen based on the community name, taken from a description provided by the user, or they may be entered directly by the user. The newly created community is placed into a category, and further keywords for the community can be selected 414 based on the category. Keywords may also be selected 414 based on a characteristic of the user, such as the user's browsing history, profile, community page, friends, or other characteristics. The data describing the new community, such as the keywords, community name, description, category and so forth, are stored in the database 130.

Next, additional actions are taken to provide 416 content to the newly created community, as follows. A search engine performs one or more searches of the Internet, for webpages, RSS feeds, and other types of content, using keywords of the community. In addition, a search engine of the social network searches for content within the online social network such as images, forum topics, and blogs. The search results may comprise news and advertising links, images, or other types of content to be provided 416 to the new online community. Code is generated by a community content module such as previously described that, when executed, displays a webpage of the community containing the content. Users and communities to which to advertise the new online communities are also identified, for instance using techniques described previously.

The users or community members identified by this community search may be sent an automatic invitation asking them to visit or join the newly created community. A community with similar keywords may also be asked to become a “related community” to the newly formed community. A community content module generates code, that, when executed, displays a webpage with links to the new online community to users and communities. This way, the new community may be populated by leveraging existing information and relationships within the social network.

One or more of the steps shown in FIG. 4 may be performed by elements on the client or server side. In addition, the steps and instructions of described could be embodied in software, firmware or hardware, and when embodied in software, could be downloaded to reside on and be operated from different platforms used by real time network operating systems. Not every possible step is shown in the figures. In addition, some embodiments perform different steps in addition to, or instead of, the ones described herein. Furthermore, the order of the steps can vary from that described herein. In other embodiments, some or all of the steps are performed by entities other than those described.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

The invention has been described in particular detail with respect to several possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of embodiments of the invention in terms of ranking functions and symbolic representations of operations on information. These ranking function descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Embodiments of the invention also include computer program products for performing various operations disclosed herein. The computer program products comprises program code that may be embodied on a computer-readable or accessible storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. One or more parts of the program code may be distributed as part of an appliance, downloaded, and/or otherwise provided to a customer.

The operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

What is claimed is:

1. A method of creating an online community within an online social network, the method comprising:
receiving from a user a search query for searching online communities within the online social network;
searching in a database of pre-existing online communities using the search query;
responsive to the search of the database yielding no results, providing the user with an option to create a new online community;
creating in the database a new online community that includes the user as a member;
searching for and locating content for the new online community; and
generating code for, when executed, displaying the located content for the new online community.

2. The method of claim 1, further comprising receiving and storing at least one of: a description, a keyword, and a name for the new online community.

3. The method of claim 2, wherein the name or keyword for the new online community is provided by the user to search the online social network for the content.

4. The method of claim 3, wherein the content comprises hyperlinks.

5. The method of claim 4, wherein the hyperlinks comprise one of: links to advertising content and links to news content.

6. The method of claim 1, further comprising, responsive to the search of the database yielding no results:
generating by a suggestion processor a revised search query;
providing the revised search query to the user; and
responsive to acceptance of the revised search query by the user, searching in the database of pre-existing online communities using the revised search query.

7. The method of claim 1, further comprising automatically assigning a name to the new online community that comprises a term of the search query.

8. The method of claim 1, further comprising identifying a pre-existing online community relevant to the new online community, and generating code that, when executed, displays a link to the new online community to the identified pre-existing online community.

9. The method of claim 1, further comprising identifying users within the social network with membership to at least one community relevant to the new online community and generating code that, when executed, displays a link to the new online community to the identified users.

10. A method of creating an online community within an online social network, the method comprising:
receiving an object to be posted to a social network;
receiving a label name to associate with the object, the label name comprising one or more terms;
searching a database of pre-existing online communities for communities that have names that contain one or more terms of the label name;
responsive to no pre-existing community being found, creating a new online community;
assigning a name to the new online community that comprises the label name; and
generating code for, when executed, displaying a webpage that includes content relating to the new online community.

11. The method of claim 10, further comprising automatically searching for and locating content for the new online community, the content comprising at least one of: links to advertising content and links to news content.

12. The method of claim 10, further comprising searching for and identifying users within the social network with membership to at least one community related or relevant to the new online community, and generating code that, when executed, displays a link to the new online community to the identified users.

13. A computer program product for creating an online community in a social network, comprising code encoded on a computer-readable medium for performing the steps of:
receiving from a user a search query for searching online communities within the online social network;
searching in a database of pre-existing online communities using the search query;
responsive to the search of the database yielding no results, providing the user with an option to create a new online community;
creating in the database a new online community that includes the user as a member;
searching for and locating content for the new online community; and
generating code for, when executed, displaying the located content for the new online community.

14. The computer program product of claim 13, wherein searching for content comprises searching the online social network using a name or keyword of the new online community provided by the user.

15. The computer program product of claim 14, wherein the content comprises hyperlinks.

16. The computer program product of claim 15, wherein the hyperlinks comprise one of: links to advertising content and links to news content.

17. The computer program product of claim 13, wherein the steps further comprise searching for and identifying a pre-existing online community relevant to the new online community and generating code that, when executed, displays a link to the new online community to the identified pre-existing online community.

18. The computer program product of claim 13, wherein the steps further comprise searching for and identifying users within the social network with membership to at least one community relevant to the new online community, and generating code that, when executed, displays a link to the new online community to the identified users.

19. The computer program product of claim 13, wherein the steps further comprise automatically assigning a name to the new online community that comprises the search query.

20. The computer program product of claim 13, wherein searching for content comprises searching the online social network using a name or keyword of the new online community.
